(19) United States
(12) Patent Application Publication
(10) Pub. No.: US 2012/0090206 A1
(43) Pub. Date: Apr. 19, 2012

(54) HitchPix

(76) Inventors: John Edwin Prescott, Vernon, NY (US); Douglas A. Tudman, Sherrill, NY (US)

(21) Appl. No.: 12/799,809

(22) Filed: Oct. 18, 2010

(51) Int. Cl. G09F 13/06; G09F 21/04

(52) U.S. Cl. 40/541

(57) ABSTRACT

The invention displays manually inserted themed artwork in a plastic unit which is inserted into a standard 2″ hitch box at rear of vehicle. The full color themed artwork is visible when brake light is off and enhanced when brake light is on. The unit body contains the LED light, reflective background, red colored plastic light diffuser, and electrical pigtail connector which plugs into the vehicle's 12 volt DC receptacle. Unit has a unique clear acrylic swing-down door that holds the acetate artwork in a built-in channel immediately behind the door. Unique acetate artwork is manually interchangeable. A square foam washer takes up tolerance between the metal hitch box and the plastic unit body. An O-ring mounted around the inside of the clear acrylic door provides a weather-tight seal protecting internal parts and artwork acetates.

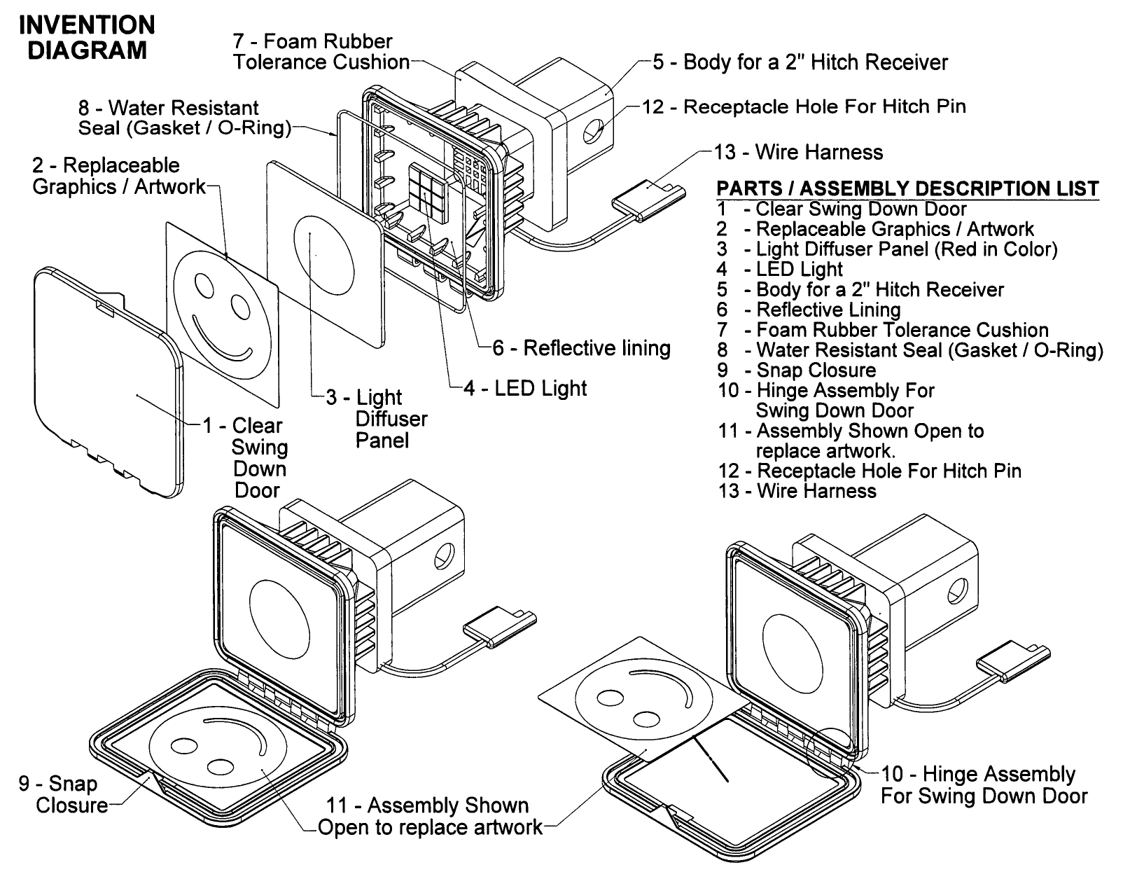

### BACKGROUND OF INVENTION

The invention relates to a manner of displaying thematic artwork in a lighted trailer hitch insert at the back of a pickup truck or other vehicle with towing capability. The thematic artwork can be changed as frequently as desired by the owner.

### DESCRIPTION OF PRIOR ART

Numerous hitch inserts have been created to fit into a hitch receptacle. These units display artwork that is static and not interchangeable or fluid—example: non-lighted car company logos. The purpose of this invention is to provide the ability to choose a wide variety of artwork themes utilizing designs created especially for the unit.

### SUMMARY OF THE INVENTION

The object of the present invention is to provide a trailer hitch box insert that is capable of displaying individual artwork themes (selected from a variety of available themes) which are mounted individually behind a hinged acrylic door. The door swings down allowing easy access to a water resistant compartment that will hold a single piece of artwork. The artwork (theme) will be printed on acetate material in full color so people viewing the artwork will see a multicolor representation of the theme (soccer ball, snowmobile, deer head, fish, Christmas wreath, pumpkin, flag, etc.),In addition, the artwork will be designed to leave key areas of the artwork free of color so the red LED light shows through clear acetate illuminating and highlighting the theme when the brake light is on.

### DESCRIPTION OF INVENTION

This invention is a product that will fit into a standard towing hitch receptacle (box) on the back of a pickup truck, SUV, or other vehicle. The product made of plastic will be held in place by a standard pin or lock-pin not supplied with product. The product is then plugged into the electrical receptacle on vehicle with a standard plug. Once attached and the vehicle brake is applied the LED light shows bright red. The uniqueness of this product is that thematic artwork is illuminated and can be changed very easily. A swing down door exposes the artwork that can be changed out by placing the new artwork in a channel designed into the back of the swing down door. Then the door is snapped shut and the new artwork is ready for illumination by the LED brake lights.

### PARTS/ASSEMBLY DESCRIPTION LIST

1. Clear swing down door
2. Replaceable graphics/artwork.
3. Plastic light diffuser panel (red in color).
4. LED light source.
5. Body for a 2″ receiver.
6. Reflective lining.
7. Foam rubber tolerance cushion
8. Water resistant seal (Gasket/O-Ring).
9. Snap closure.
10. Hinge assembly for swing down door.
11. Assembly shown open for replacing artwork (theme).
12. Receptacle hole for Hitch Pin
13. Wire harness

### EXPLANATION OF DIAGRAM

1 The swing-down door is clear plastic allowing high visibility of the artwork.
2 The replaceable artwork/themes are interchangeable allowing countless possibilities for displaying a person's favorite theme, i.e., sports, holidays, patriotic, school names, logos, etc.
3 The light diffuser panel disperses the light from the LED light source preventing hot spots and promoting clear and even dispersal of light which will enhance the visibility and clarity of the theme through the swing-down door panel.
4 LED light source provides the brightest and most reliable light available.
5 The 2″ body will fit every 2″ trailer hitch receiver.
6 Reflective lining magnifies the brightness of the original LED light.
7 Foam rubber tolerance cushion assures a secure fit between plastic hitch-light shaft and hitch receptacle as dimensions may vary slightly from hitch to hitch.
8 Water resistant seal (Gasket/O-Ring) assures the artwork will remain dry while in use.
9 Snap closure holds the clear plastic swing down door snuggly in place providing a tight seal and allowing the artwork to remain dry and in proper position.
10 Plano-type hinge assembly for swing down door provides a strong mechanism for countless openings and closings.
11 Artwork is easily changed as clear acrylic swing-down door opens wider than 180 degrees.
12 Receptacle hole lines up with hole in trailer hitch receiver and accepts locking hitch pin that secures HitchPix unit in place.
13 Wire Harness

We claim:

1. (canceled)

2. (canceled)

3. A decorative and protective cover element for a vehicle, truck, or auto trailer hitch assembly, said vehicle trailer hitch assembly comprising a means for attachment to the trailer hitch receptacle at rear end of said vehicle, an adjustable draw-hitch element for receiving a ball hitch, said protective cover element comprising:
a. a rectangular shaft comprised of a length and two ends, one of said ends being insertable within said adjustable draw-hitch receiving element and attachable thereto, said insert shaft having a longitudinal axis and at least two openings along said length perpendicular to said longitudinal axis;
b. a pin passing through holes in said vehicle trailer hitch assembly and corresponding holes in rectangular shaft for attaching said insert member to said adjustable draw-hitch receiving element;
c. a foam tolerance cushion separates and cushions said decorative and protective cover element from said trailer hitch assembly;
d. a graphics/artwork receptacle element directly attached to the other end of said insert member, said graphics/artwork receptacle element comprising a housing member and a transparent lens member;
e. a replaceable graphics/artwork film inserted within said transparent lens member; and,
f. a lighting means for illuminating said graphics/artwork, so that when said ball hitch is removed from said draw-hitch element, said insert shaft can be placed therein to provide a protective cover therefor and to provide an illuminated graphic/artwork element at rear of said vehicle.

4. the protective cover element of claim 3 wherein said graphics/artwork is displayed.

5. the protective cover element of claim 3 wherein said replaceable graphics/artwork is static charged film.

6. the protective cover element of claim 3 wherein said LED lighting source includes 12 volt electrical power.

7. the protective cover element of claim 3 wherein said lens member is a clear material swing-down door comprised of multi-segmented long hinge opening to 180 degree angle and is removable.

8. the protective cover element of claim 5 wherein said lens member is recessed on inside surface conforming to size and shape of said replaceable graphics/artwork film.

9. the housing member body of claim 3 wherein includes a rubber O-Ring providing weather-tight seal when said protective cover element is snapped into closed position.
